(19) United States
(12) Patent Application Publication
(10) Pub. No.: US 2024/0412180 A1
(43) Pub. Date: Dec. 12, 2024

(54) MULTI-CHANNEL ELECTRONIC TRANSACTION COMMUNICATIONS USING REDUCED RESOURCES

(71) Applicant: Truist Bank, Charlotte, NC (US)

(72) Inventors: Kendra Henry, Charlotte, NC (US); Luana Peterman, Lancaster, NC (US)

(73) Assignee: Truist Bank, Charlotte, NC (US)

(21) Appl. No.: 18/331,312

(22) Filed: Jun. 8, 2023

(51) Int. Cl. G06Q 20/10

(52) U.S. Cl. CPC G06Q 20/10

(57) ABSTRACT

A system for facilitating multi-channel electronic message communications within a transaction processing system. The system may include a transaction manager component that receives transaction request electronic messages of various formats, consolidates the transaction request electronic messages into a combined electronic message having a universal format, and transmits the combined electronic message to a transaction server component via a single transmission pathway for further processing, which reduces required management, processor, and memory resources. Individual transaction request electronic messages may be separated from the combined electronic message by the transaction server component while retaining their original formats and can be subsequently sent, based on message format, to proper downstream systems for further processing. A further message augmentation component may identify and automatically correct errors in transaction request electronic messages received by the transaction manager component so as to circumvent possible downstream processing problems.

### TECHNICAL FIELD

The present disclosure relates generally to electronic transaction systems, and more particularly, although not exclusively, to conserving memory and processor resources by facilitating transaction request electronic message communications.

### BACKGROUND

An electronic transaction, such as a wire transaction, can be made between persons, between entities, or between some combination thereof. An electronic transaction is typically initiated by transmitting an electronic message conveying a transaction processing request to a processing entity. Such electronic messages may include various information about the requested electronic transaction, such as for example, identifying information about the initiating and receiving party, account information, sending entity information, etc. Such an electronic message may be transmitted by an initiating party via a channel of what is commonly a plurality of channels by which the receiving entity receives wire transaction request electronic messages. Wire transaction request electronic messages may have different formats based on wire transaction type or otherwise, which formats are associated with and processible by particular components of a transaction processing system of the receiving entity. Wire transaction request electronic messages may sometimes be received at the entity with incomplete or improper transaction information.

While an entity may receive multiple wire transaction request electronic messages through a plurality of different channels, it may be preferable at least for purposes of simplicity and efficiency, that downstream transmission of such electronic messages be limited to a single pathway. However, transmitting a plurality of received wire transaction request electronic messages for downstream processing on a one message at a time basis is inefficient, and can consume significant user, processor, and memory resources.

### SUMMARY

According to one example of the present disclosure, a system may include a processor, and memory that is communicatively coupled to the processor and includes instructions that are executable by the processor to cause the processor to perform operations. The operations may include receiving, by a transaction manager component, from a plurality of different initiating channels, multiple transaction request electronic messages having various formats. The operations may also include consolidating, by a message consolidation element of the transaction manager component, each of the individual transaction request electronic messages of an original format into a combined electronic message having a universal format that is readable by a downstream transaction server component. The operations may additionally include transmitting the combined electronic message, by the transaction manager component to the transaction server component, via a single transmission pathway therebetween, and separating, by the transaction server component, the individual transaction request electronic messages from the combined electronic message, with each of the individual transaction request electronic messages retaining its original format. The operations may further include determining, by the transaction server component, the formats of the individual transaction request electronic messages, and directing, by a router of the transaction server component, the individual transaction request electronic messages to respective ones of a plurality of downstream systems based on the formats of the individual transaction request electronic messages.

According to another example of the present disclosure, a non-transitory computer readable medium may contain instructions that are executable by a processor to cause the processor to perform operations. The operations may include receiving, by a transaction manager component, from a plurality of different initiating channels, multiple transaction request electronic messages having various formats. The operations may also include consolidating, by a message consolidation element of the transaction manager component, each of the individual transaction request electronic messages of an original format into a combined electronic message having a universal format that is readable by a downstream transaction server component. The operations may additionally include transmitting the combined electronic message, by the transaction manager component to the transaction server component, via a single transmission pathway therebetween, and separating, by the transaction server component, the individual transaction request electronic messages from the combined electronic message, with each of the individual transaction request electronic messages retaining its original format. The operations may further include determining, by the transaction server component, the formats of the individual transaction request electronic messages, and directing, by a router of the transaction server component, the individual transaction request electronic messages to respective ones of a plurality of downstream systems based on the formats of the individual transaction request electronic messages.

According to a further example of the present disclosure, a computer-implemented method may include receiving, by a transaction manager component of a transaction processing system, from a plurality of different initiating channels, multiple individual transaction request electronic messages having various formats. The method may also include consolidating, by a message consolidation element of the transaction manager component, each of the individual transaction request electronic messages of an original format into a combined electronic message having a universal format that is readable by a downstream transaction server component. The method may additionally include transmitting, by the transaction manager component to the transaction server component, via a single transmission pathway therebetween, the combined electronic message, and separating, by the transaction server component, the individual transaction request electronic messages from the combined electronic message, with each of the individual transaction request electronic messages retaining its original format. The method may further include determining, by the transaction server component, the format of each individual transaction request electronic messages, and directing, by a router of the transaction server component, the individual transaction request electronic messages to respective ones of a plurality of downstream systems based on the formats of the individual transaction request electronic messages.

### BRIEF DESCRIPTION OF THE DRAWINGS

FIG. 1 is a schematic diagram representing one example of a computing environment within which wire transactions can take place, according to an example of the present disclosure.

FIG. 2 is a block diagram of a system for facilitating multi-channel electronic message communications, according to an example of the present disclosure.

FIG. 3 is another block diagram of a system for facilitating multi-channel electronic message communications, according to another example of the present disclosure.

FIG. 4 is a flowchart of a computerized method for facilitating multi-channel electronic message communications, according to one example of the present disclosure.

### DETAILED DESCRIPTION

Aspects of the present disclosure are directed to a system for facilitating multi-channel electronic message communications. Examples of the system can include a transaction manager component, and a transaction server component that is downstream of the transaction manager component. The transaction manager component may receive multiple transaction (e.g., wire transaction) request electronic messages of various formats from a plurality of different initiating channels. The transaction manager may include a message consolidation element that can consolidate the multiple transaction request electronic messages into a combined electronic message having a universal format that is readable by a downstream transaction server component, while allowing the individual transaction request electronic messages in the combined electronic message to retain their original formats. The transaction server component can receive the combined electronic message from the message consolidation element via a single transmission pathway between the transaction manager component and the transaction server component, and can thereafter separate the individual transaction request electronic messages from the combined electronic message for further processing, with each of the individual transaction request electronic messages retaining its original format. This reduces the amount of management, processor, and memory resources required by the transaction processing system. After the individual transaction request electronic messages are separated from the combined electronic message, a router of the transaction server component can direct the individual electronic messages to respective ones of a plurality of downstream systems based on the formats of the individual transaction request electronic messages. This reduces processing time, and can also conserve processor and memory resources by eliminating possible searching, reformatting, reconfiguration, or other operations that might otherwise be required at a downstream systems layer.

In system examples according to the present disclosure, the transaction manager component can also include a message augmentation element that is able to automatically detect an error, such as missing transaction information, in a transaction request electronic message. Upon detection of an error, the message augmentation element can correct the error, such as by locating and retrieving the missing information and amending the transaction request electronic message by populating the transaction request electronic message with the retrieved information. The message augmentation element preferably operates to correct transaction request electronic message errors prior to message consolidation by the message consolidation element, or at least prior to transmission of the combined electronic message to the transaction server component. As such, operation of the message augmentation element can also conserve processor and memory resources that would otherwise be required to troubleshoot processing delays or problems at the transaction server or further downstream that are caused by electronic message errors.

The following illustrative examples are provided to introduce the reader to the general subject matter discussed herein, and are not intended to limit the scope of the disclosed concepts. In the following description, specific details are set forth in order to provide a thorough understanding of various implementations and examples. Various implementations may be practiced without these specific details. The figures and description are not intended to be restrictive.

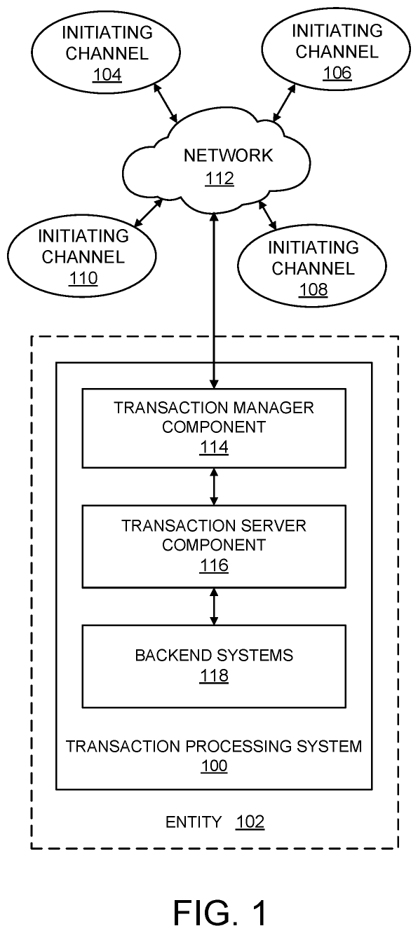

FIG. 1 is a block diagram representing an example of a computing environment within which wire transaction requests can be processed. As represented, a transaction processing system 100 of an entity 102 can receive wire transaction request electronic messages (also referred to hereinafter as “transaction request electronic messages”) from a plurality of initiating channels 104, 106, 108, 110. Although four initiating channels 104, 106, 108, 110 are shown in FIG. 1 for purposes of illustration, a different number of initiating channels may be present in other examples. A given transaction processing system can receive transaction processing requests from numerous initiating channels.

The initiating channels 104-110 can transmit transaction request electronic messages to the transaction processing system 100 via a network 112.

The network 112 may be without limitation, a local area network (LAN), a wide-area network (WAN) such as the Internet, an institutional network, cellular or other wireless networks, virtual networks such as an intranet or an extranet, etc.

The transaction processing system 100 example of FIG. 1 is shown to include a transaction manager component 114 and a transaction server component 116. The transaction manager component 114 can receive the transaction request electronic messages from the plurality of initiating channels 104, 106, 108, 110. Although, not shown for reasons of clarity, the transaction manager component 114 may include a plurality of message queues within which received electronic messages may be temporarily stored for subsequent downstream transmission. Likewise, one or more gateways, integration layers, or other components may reside between the channels 104-110 and the transaction manager component 114.

The transaction server component 116 can be communicatively coupled to the transaction manager component 114. The transaction server component 116 can run one or more applications, such as but not limited to, applications for processing wire transactions. The transaction server component 116 receives transaction request electronic messages from the transaction manager component 114, and is operative to process wire transactions, including by transmitting wire transaction requests to downstream systems, such as core or other backend systems 118 of the entity 102.

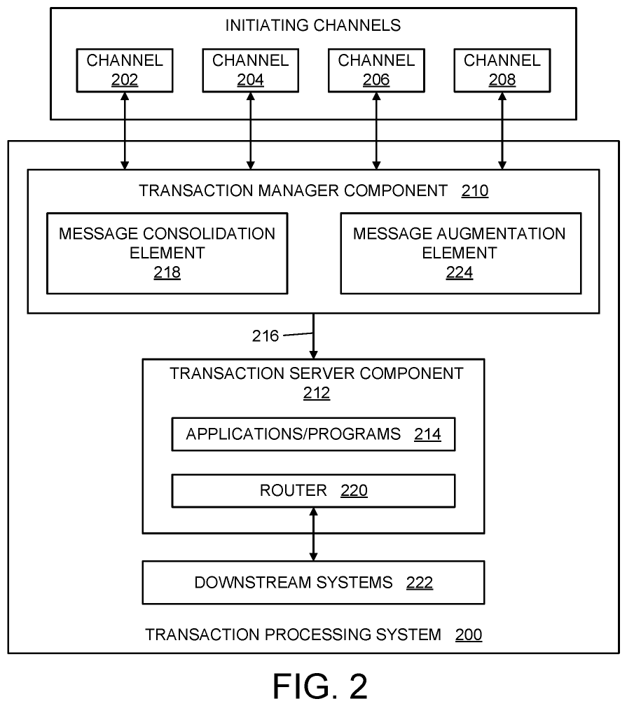

FIG. 2 is a block diagram of a transaction processing system 200 for facilitating multi-channel electronic message communications, according to an example of the present disclosure. As represented, the transaction processing system 200 can receive wire transaction processing requests from a plurality of initiating channels 202, 204, 206, 208. While only four initiating channels 202-208 are shown in FIG. 2 for reasons of clarity, it should be realized that a transaction processing system like the transaction processing system 200 may receive transaction processing requests via a greater or lesser number of initiating channels. In practice, a given wire transaction processing system can receive transaction processing requests from a multitude of different initiating channels.

The transaction processing system 200 receives transaction processing requests in the form of electronic messages. The individual electronic messages transmitted via the initiating channels 202-208 can have various formats depending on the nature (type) of the associated wire transaction being requested. For example, and without limitation, requests may be received to process domestic wire transactions, international wire transactions such as SWIFT transactions, international letters of credit, or batch wire transactions that employ an electronic data interchange (EDI) format.

The transaction processing system 200 can include a transaction manager component 210 for receiving individual transaction request electronic messages in their various original formats, as well as a transaction server component 212 that is operative for performing wire transaction processing operations. The transaction server component 212 is communicatively coupled with the transaction manager component 210 so as to receive transaction request electronic messages from the transaction manager component 210.

A number of different applications or programs 214 for processing wire transactions may operate on the transaction server component 212. A given application or program may be configured to process only one type of wire transaction and to read electronic messages having a particular corresponding format. Alternatively, a given application or program may be configured to process different types of wire transactions and to read electronic messages having various corresponding formats.

While the transaction server component 212 may include applications or programs 214 capable of processing each of the various types of wire transactions that may be received by the transaction processing system 200 and reading the associated electronic messages by which requests to process the wire transactions are conveyed, transmitting electronic messages of each possible format over corresponding unique pathways to the transaction server component 212 is inefficient from a management, processor, and memory resource standpoint. Consequently, transaction processing system 200 examples according to the present disclosure can provide a single transmission pathway 216 between the transaction manager component 210 and the transaction server component 212.

To facilitate the transmission of transaction request electronic messages from the transaction manager component 210 to the transaction server component 212 via the single transmission pathway 216, the transaction manager component 210 can include a message consolidation element 218. The message consolidation element 218 can consolidate each of the individual transaction request electronic messages received by the transaction manager component 210 in an original format, into a combined electronic message having a universal format that is readable by the downstream transaction server component 212. Although the individual transaction request electronic messages are consolidated by the transaction manager component 210 into a combined electronic message having a universal format, each of the individual transaction request electronic messages retains its original format within the combined electronic message.

Subsequent to receipt by the transaction server component 212 of the combined electronic message of universal format, the transaction server component 212 can separate the individual transaction request electronic messages from the combined electronic message. While a given application or program of the applications or programs 214 operating on the transaction server component 212 may be programmed or otherwise configured to read or decode a transaction request electronic message having a particular format, other applications or programs may not be compatible with the particular format of a given transaction request electronic message. Therefore, in order to avoid the need to perform searching, reformatting, reconfiguration, or other operations, each of the individual transaction request electronic messages preferably retains its original format after separation from the combined electronic message. This allows the transaction server component 212 to easily determine where a given transaction request electronic message should be sent for further processing, which conserves processor and memory resources.

An individual transaction request electronic message that is consolidated into a combined electronic message by the message consolidation element 218 and subsequently separated at the transaction server component 212, may also retain various transaction information included in the original transaction request electronic message. For example, and without limitation, the individual transaction request electronic messages can include transaction identifiers, and the transaction identifiers can be retained by the individual transaction request electronic messages subsequent to consolidation by the message consolidation element 218 and later separation at the transaction server component 212.

Transaction request electronic messages received by the transaction manager component 210 may also be consolidated in a sequential manner by the message consolidation element 218. For example, transaction request electronic messages may be consolidated such that, upon subsequent separation at the transaction server component 212, the individual transaction request electronic messages will be processed or transmitted for processing in an order in which the individual transaction request electronic messages were originally received by the transaction manager component 210. Other sequential consolidation techniques, or different ordering techniques, may also be employed during message consolidation. It is also possible is some examples for the message consolidation element 218 to resequence transaction request electronic messages during message consolidation.

In furtherance of facilitating transaction request electronic message communications, the transaction server component 212 may include a router 220. In some system examples, the router 220 can determine the format of each separated transaction request electronic message. The router 220 can direct each transaction request electronic message to a particular application or program of the transaction server component 212, or to respective ones of a plurality of downstream systems, based on the formats of the individual transaction request electronic messages.

The transaction processing system 200 may include or be associated with various downstream systems 222 to which transaction request electronic messages may be transmitted by the transaction server component 212 for further processing of the associated wire transactions. Such downstream systems 222 may be backend or core systems of the entity 102, data systems in communication with one or more databases storing customer, account or other wire transaction-related information, or one or more other systems, as would be well understood by one of skill in the art.

As indicated in FIG. 2, the transaction manager component 210 may further include a message augmentation element 224 according to examples of the present disclosure. The message augmentation element 224 can identify an error in a transaction request electronic message received by the transaction manager component 210, and can operate to correct the error. For example, the transaction manager component 210 may receive a transaction request electronic message having missing transaction information (e.g., a missing bank identifier). In such an example, the message augmentation element 224 can identify the bank identifier as missing, locate the missing bank identifier, and populate the associated transaction request electronic message with the missing bank identifier. The message augmentation element 224 may locate missing transaction information by various techniques, such as by analyzing other transaction information included in the transaction request electronic message from which transaction information is determined to be missing, and communicating with one or more databases or other systems from which the missing information may be retrieved.

The message augmentation element 224 preferably operates to correct transaction request electronic message errors prior to message consolidation by the message consolidation element 218, or at least prior to transmission of the combined electronic message to the transaction server component 212. Correcting transaction request electronic message errors prior to message consolidation or combined electronic message transmission can conserve processor and memory resources that might otherwise be required to troubleshoot processing delays or problems at the transaction server component 212 or further downstream as a result of transaction request electronic message errors.

Subsequent to receipt by and separation of a combined electronic message into individual transaction request electronic messages by the transaction server component 212, a responsive electronic message may be generated relative to a received transaction request electronic message or several or all of the received transaction request electronic messages. Likewise, a responsive electronic message may be generated by the downstream systems 222 relative to a received transaction request electronic message or several or all of a plurality of received transaction request electronic messages. A responsive electronic message generated by the transaction server component 212 or the downstream systems 222 can be transmitted to the transaction manager component 210 via the single transmission pathway 216 between the transaction server component 212 and the transaction manager component 210.

A responsive transaction request electronic message received by the transaction manager component 210 can be further transmitted to the initiating channel 202, 204, 206, 208 from which the associated transaction request electronic message originally emanated.

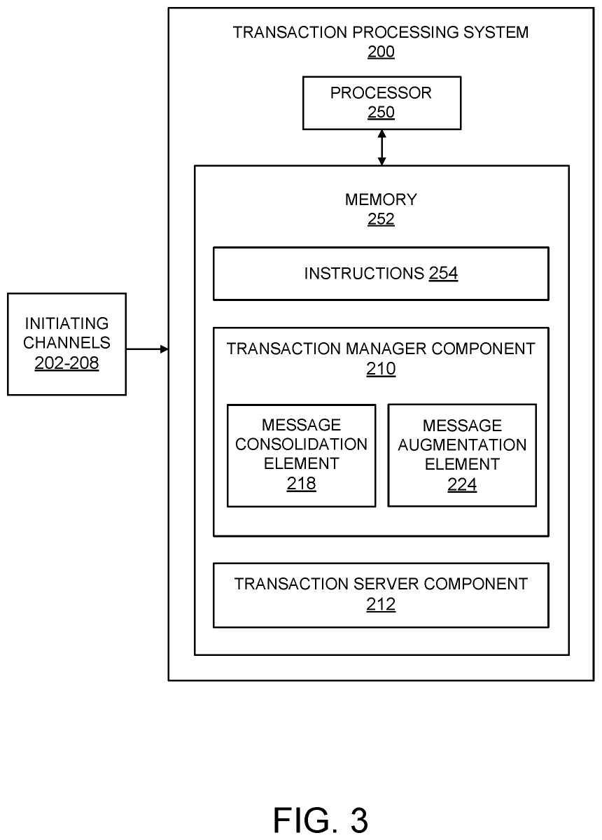

FIG. 3 is another block diagram of a system for facilitating multi-channel electronic message communications within a transaction processing system, such as the transaction processing system 200 example described above with respect to the diagram of FIG. 2. As shown, the transaction processing system 200 may include a processor 250 that is communicatively coupled to a memory 252. The processor 250 can include one processing device or multiple processing devices. Non-limiting examples of the processor 250 include a Field-Programmable Gate Array (FPGA), an application-specific integrated circuit (ASIC), a microprocessor, etc. The processor 250 can execute instructions 254 stored in the memory 252 to perform operations, such as but not limited to, the previously described message consolidation, message augmentation, and message routing operations. In some examples, the instructions 254 can include processor-specific instructions generated by a compiler or an interpreter from code written in a suitable computer-programming language, such as C, C++, C#, etc.

The memory 252 can include one memory or multiple memories. The memory 252 can be non-volatile and may include any type of memory that retains stored information when powered off. Non-limiting examples of the memory 252 include electrically erasable and programmable read-only memory (EEPROM), flash memory, or any other type of non-volatile memory. At least some of the memory 252 can be a non-transitory computer-readable medium from which the processor 250 can read the instructions 254. A computer-readable medium can include electronic, optical, magnetic, or other storage devices capable of providing the processor 250 with computer-readable instructions or other program code. Non-limiting examples of a computer-readable medium include magnetic disk(s), memory chip(s), ROM, random-access memory (RAM), an ASIC, a configured processor, optical storage, or any other medium from which the processor 250 can read the instructions 254.

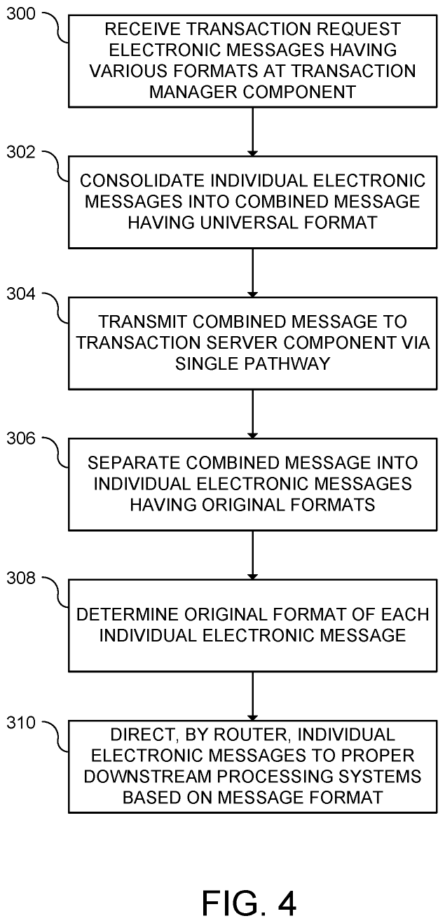

FIG. 4 is a flowchart of a computerized method for facilitating multi-channel electronic message communications, according to one example of the present disclosure. As represented, at block 300, a transaction manager component of a transaction processing system receives, from a plurality of initiating channels, a multitude of transaction request electronic messages. At block 302, a message consolidation element of the transaction manager component consolidates each individual transaction request electronic message of an original format into a combined electronic message having a universal format that is readable by a downstream transaction server component. At block 304, the transaction manager component transmits the combined electronic message to the transaction server component via a single transmission pathway therebetween. At block 306, the transaction server component separates the individual transaction request electronic messages from the combined electronic message, with each of the individual transaction request electronic messages retaining its original format. At block 308, a router of the transaction server component determines the format of each individual transaction request electronic message, and subsequently directs the individual transaction request electronic messages to respective ones of a plurality of downstream systems based on the determined formats of the individual transaction request electronic messages, as indicated at block 310.

The foregoing description of certain examples, including illustrated examples, has been presented only for purposes of illustration and description and is not intended to be exhaustive or to limit the disclosure specifically to wire transaction processing systems or to any other precise forms disclosed. Numerous modifications, adaptations, and uses thereof will be apparent to those skilled in the art without departing from the scope of the disclosure.

What is claimed is:

1. A system, comprising:
a processor;
memory communicatively coupled to the processor, the memory including instructions that are executable by the processor to cause the processor to:
receive, by a transaction manager component, from a plurality of different initiating channels, multiple individual transaction request electronic messages having various formats;
consolidate, by a message consolidation element of the transaction manager component, each of the individual transaction request electronic messages of an original format into a combined electronic message having a universal format that is readable by a downstream transaction server component;
transmit the combined electronic message, by the transaction manager component to the transaction server component, via a single transmission pathway therebetween;
separate, by the transaction server component, the individual transaction request electronic messages from the combined electronic message, with each of the individual transaction request electronic messages retaining its original format;
determine, by the transaction server component, the original formats of the individual transaction request electronic messages; and
direct, by a router of the transaction server component, the individual transaction request electronic messages to respective ones of a plurality of downstream systems based on the formats of the individual transaction request electronic messages.

2. The system of claim 1, wherein the memory includes instructions that are executable by the processor to further cause the processor to, prior to consolidation of the individual transaction request electronic messages into the combined electronic message by the message consolidation element:
identify, by a message augmentation element of the transaction manager component, an error in one or more of the individual transaction request electronic messages; and
correct, by the message augmentation element, the error in the one or more individual transaction request electronic messages.

3. The system of claim 2, wherein the error is missing transaction information and the memory includes instructions that are executable by the processor to further cause the message augmentation element to locate the missing transaction information and to populate the one or more individual transaction request electronic messages with the missing transaction information.

4. The system of claim 1, wherein the individual transaction request electronic messages include transaction identifiers, and the transaction identifiers are retained by the individual transaction request electronic messages after the individual transaction request electronic messages are consolidated into the combined electronic message.

5. The system of claim 1, wherein the memory includes instructions that are executable by the processor to further cause the message consolidation element to consolidate the individual transaction request electronic messages in a sequential manner.

6. The system of claim 1, wherein the memory includes instructions that are executable by the processor to further cause the transaction server component to generate a responsive electronic message relative to a received transaction request electronic message, and to transmit the responsive electronic message to the transaction manager component via the single transmission pathway between the transaction server component and the transaction manager component.

7. The system of claim 6, wherein the memory includes instructions that are executable by the processor to further cause the transaction manager component to transmit the responsive electronic message to the initiating channel from which the transaction request electronic message emanated.

8. A non-transitory computer-readable medium comprising instructions that are executable by a processor for causing the processor to:
receive, by a transaction manager component, from a plurality of different initiating channels, multiple individual transaction request electronic messages having various formats;
consolidate, by a message consolidation element of the transaction manager component, each of the individual transaction request electronic messages of an original format into a combined electronic message having a universal format that is readable by a downstream transaction server component;
transmit the combined electronic message, by the transaction manager component to the transaction server component, via a single transmission pathway therebetween;
separate, by the transaction server component, the individual transaction request electronic messages from the combined electronic message, with each of the individual transaction request electronic messages retaining its original format;
determine, by the transaction server component, the original formats of the individual transaction request electronic messages; and
direct, by a router of the transaction server component, the individual transaction request electronic messages to respective ones of a plurality of downstream systems based on the formats of the individual transaction request electronic messages.

9. The non-transitory computer-readable medium of claim 8, wherein the instructions of the non-transitory computer-readable medium are executable by the processor for further causing the processor to, prior to consolidation of the individual transaction request electronic messages into the combined electronic message by the message consolidation element:
identify, by a message augmentation element of the transaction manager component, an error in one or more of the individual transaction request electronic messages; and
correct, by the message augmentation element, the error in the one or more individual transaction request electronic messages.

10. The non-transitory computer-readable medium of claim 9, wherein the error is missing transaction information and the instructions of the non-transitory computer-readable medium are executable by the processor for further causing the message augmentation element to locate the missing transaction information and to populate the one or more individual transaction request electronic messages with the missing transaction information.

11. The non-transitory computer-readable medium of claim 8, wherein the individual transaction request electronic messages include transaction identifiers, and the transaction identifiers are retained by the individual transaction request electronic messages after the individual transaction request electronic messages are consolidated into the combined electronic message.

12. The non-transitory computer-readable medium of claim 8, wherein the instructions of the non-transitory computer-readable medium are executable by the processor for further causing the message consolidation element to consolidate the individual transaction request electronic messages in a sequential manner.

13. The non-transitory computer-readable medium of claim 8, wherein the instructions of the non-transitory computer-readable medium are executable by the processor for further causing the transaction server component to generate a responsive electronic message relative to a received transaction request electronic message, and to transmit the responsive electronic message to the transaction manager component via the single transmission pathway between the transaction server component and the transaction manager component.

14. The non-transitory computer-readable medium of claim 13, wherein the instructions of the non-transitory computer-readable medium are executable by the processor for further causing the transaction manager component to transmit the responsive electronic message to the initiating channel from which the transaction request electronic message emanated.

15. A computer-implemented method comprising:
receiving, by a transaction manager component of a transaction processing system, from a plurality of different initiating channels, multiple individual transaction request electronic messages having various formats;
consolidating, by a message consolidation element of the transaction manager component, the individual transaction request electronic messages of an original format into a combined electronic message having a universal format that is readable by a downstream transaction server component;
transmitting, by the transaction manager component to the transaction server component, via a single transmission pathway therebetween, the combined electronic message;
separating, by the transaction server component, the individual transaction request electronic messages from the combined electronic message, with each of the individual transaction request electronic messages retaining its original format;
determining, by the transaction server component, the original formats of the individual transaction request electronic messages; and
directing, by a router of the transaction server component, the individual transaction request electronic messages to respective ones of a plurality of downstream systems based on the formats of the individual transaction request electronic messages.

16. The computer-implemented method of claim 15, further comprising, prior to consolidating the individual electronic messages into the combined electronic message by the message consolidation element of the transaction manager component:
identifying, by a message augmentation element of the transaction manager component, an error in one or more of the individual transaction request electronic messages; and
amending, by the message augmentation element, the one or more individual transaction request electronic messages to eliminate the error.

17. The computer-implemented method of claim 15, wherein the individual transaction request electronic messages include transaction identifiers, and the message consolidation element of the transaction manager component preserves the transaction identifiers during consolidation of the individual transaction request electronic messages into the combined electronic message.

18. The computer-implemented method of claim 15, wherein the message consolidation element determines, from the transaction manager component, a sequence in which the individual transaction request electronic messages were received by the transaction manager component, and the message consolidation element maintains the sequence when consolidating the individual transaction request electronic messages into the combined electronic message.

19. The computer-implemented method of claim 15, further comprising:
generating, by the transaction server component, a responsive electronic message relative to a received transaction request electronic message;
transmitting the responsive electronic message by the transaction server component to the transaction manager component, via the single transmission pathway between the transaction server component and the transaction manager component; and
transmitting, by the transaction manager component, the responsive electronic message to the initiating channel of the plurality of initiating channels from which the transaction request electronic message emanated.
